(19) United States
(12) Patent Application Publication
(10) Pub. No.: US 2024/0222672 A1
(43) Pub. Date: Jul. 4, 2024

(54) PROTON EXCHANGE MEMBRANE

(71) Applicant: Arkema France, Colombes (FR)

(72) Inventors: Anthony BONNET, Colombes (FR); Samuel DEVISME, Serquigny (FR); Helene MEHEUST, Serquigny (FR)

(21) Appl. No.: 18/563,036

(22) PCT Filed: May 31, 2022
(86) PCT No.: PCT/FR2022/051033

§ 371 Date: Nov. 21, 2023

(30) Foreign Application Priority Data
May 31, 2021 (FR) FR21.05701

(51) Int. Cl. H01M 8/1039; H01M 8/10; H01M 8/1023; H01M 8/103; H01M 8/1032; H01M 8/1044; H01M 8/1072; H01M 8/1088

(52) U.S. Cl. CPC H01M 8/1039; H01M 8/1023; H01M 8/103; H01M 8/1032; H01M 8/1044; H01M 8/1072; H01M 8/1088; H01M 2008/1095

(57) ABSTRACT

The present invention relates to a proton exchange membrane, to the process for preparing said membrane, and to the application of said membrane in fields requiring ion exchange, such as effluent purification and electrochemistry or in energy fields. In particular, this membrane is used in the design of fuel cell membranes.

### FIELD OF THE INVENTION

The present invention relates to a proton exchange membrane, the process for preparing said membrane, and the application of said membrane in fields requiring ion exchange, such as electrochemistry or in energy fields. In particular, this membrane is used in the design of fuel cell membranes, such as proton-conducting membranes for H₂/air or H₂/O₂ fuel cells (these cells being known by the abbreviation PEMFC for “Proton Exchange Membrane Fuel Cell”) or methanol/air fuel cells (these cells being known by the abbreviation DMFC for “Direct Methanol Fuel Cell”).

### TECHNICAL BACKGROUND

A fuel cell is an electrochemical generator which converts the chemical energy of a fuel oxidation reaction in the presence of an oxidant, to electrical energy, heat and water. In general, a fuel cell comprises a plurality of electrochemical cells mounted in series, each cell comprising two electrodes of opposite polarity separated by a proton exchange membrane acting as a solid electrolyte. The membrane allows the protons formed during the oxidation of the fuel at the anode to pass to the cathode.

The membranes structure the core of the fuel cell and they must consequently have good proton conduction performance and also low permeability to the reactive gases (H₂/air or H₂/O₂ for PEMFC fuel cells and methanol/air for DMFC fuel cells). The properties of the materials constituting the membranes are essentially thermal stability, resistance to hydrolysis and oxidation, and a degree of mechanical flexibility.

Membranes commonly used and meeting these requirements are membranes obtained from polymers belonging, for example, to the family of polysulfones, polyetherketones, polyphenylenes and polybenzimidazoles. However, it has been found that these nonfluorinated polymers degrade relatively rapidly in a fuel cell environment, and their service life remains, for the time being, insufficient for the PEMFC application.

Most proton exchange membranes are based on the chemistry of perfluorinated polymers possessing long or short branches bearing a sulfonate function. In addition to their high cost, these various polymers have a low resistance to hydroxide radicals, which limits their durability in a fuel cell environment, and a low mechanical strength. These membranes furthermore have an ionic conductivity/hydrogen permeability ratio that does not make it possible to obtain thin membranes that combine high impermeability and high conductivity. Moreover, perfluorinated membranes have a temperature use limit that does not allow them to operate at temperatures above 80° C. for long periods of time.

In order to obtain long-term efficiency in terms of proton conduction at temperatures above 80° C., some authors have proposed more complex materials comprising, in addition to a polymer matrix, proton-conducting particles, the conductivity thus no longer being attributed solely to the polymer(s) constituting the membranes. This is the case for application WO 2014/173885, which describes composite materials comprising a polymer matrix and a filler consisting of inorganic ion-exchange particles, said particles being synthesized in situ within the fluorinated polymer matrix. These membranes exhibit a more homogeneous distribution of the inorganic particles within the polymer matrix. However, this type of membrane has lower mechanical properties compared to a membrane made of polymer matrix alone, a risk of cavitation at the particle-matrix interface due to variations in dimensions during the operation of the fuel cell, and is difficult to manufacture on an industrial scale.

Ion-conducting membranes produced by radiation-induced grafting are another option for improving their chemical stability. The radiation-induced grafting reaction is controlled by the diffusion of the monomers in the film and the monomer polymerization reactions. The reaction starts at the surface of the irradiated film and gradually moves through the bulk of the film. Films based on ethylene-tetrafluoroethylene (ETFE), fluorinated ethylene-propylene (FEP) and ethylene-chlorotrifluoroethylene (ECTFE) have been described, in particular for amphoteric ion exchange membranes.

There is a real need for proton exchange membranes that have improved properties, in particular improved thermal resistance and a higher conductivity/gas permeability ratio.

### SUMMARY OF THE INVENTION

To overcome the abovementioned drawbacks, the inventors have developed a membrane that has a very particular morphology obtained starting from a vinylidene fluoride-based copolymer.

According to a first aspect, the invention relates to a proton exchange polymer electrolyte membrane, said membrane consisting of an irradiated vinylidene fluoride (VDF) copolymer base film onto which are grafted a styrene monomer and a nitrile monomer, said film bearing proton exchange sulfonate groups covalently bonded to the VDF copolymer.

This VDF copolymer is first converted into film form by any technique known to those skilled in the art: extrusion-blow molding, flat-film extrusion but also, for example, film production by solvent casting. The film thus obtained has a co-continuous morphology, with a VDF-rich, highly crystalline phase which may contain up to 10% of comonomer, and an amorphous or quasi-amorphous phase based on a VDF copolymer containing more than 5% of comonomer and up to 35% of comonomer.

According to a second aspect, the invention relates to a process for producing the proton exchange polymer electrolyte membrane, said process comprising the grafting of an irradiated VDF copolymer film with a mixture of styrene and nitrile monomers, followed by a post-treatment of the film thus irradiated and grafted, by sulfonation.

According to another aspect, the invention relates to the applications of the proton exchange polymer electrolyte membrane, in the following fields:
fuel cells, for example H₂/air or H₂/O₂ fuel cells or methanol/air fuel cells;
electrolyzers;
lithium batteries, it being possible for said membranes to be part of the composition of the electrolytes.

The present invention makes it possible to overcome the disadvantages of the prior art. More particularly, it provides a technology that makes it possible to:
improve the thermal resistance of the film with no flow for a temperature below 140° C.;
improve the resistance to hydroxide radicals compared to commercial NAFION-type membranes;
improve the conductivity/hydrogen permeability ratio compared to the prior art.

### DESCRIPTION OF EMBODIMENTS OF THE INVENTION

The invention is now described in greater detail and in a nonlimiting manner in the description that follows.

According to a first aspect, the invention relates to a proton exchange polymer electrolyte membrane, said membrane consisting of a vinylidene fluoride copolymer base film onto which are grafted, by irradiation, a styrene monomer and a nitrile monomer, said film bearing proton exchange sulfonate groups covalently bonded to the VDF copolymer, said copolymer having a heterogeneous structure of co-continuous type.

According to various embodiments, said electrode comprises the features below, in combination where appropriate. The contents indicated are expressed by weight, unless otherwise indicated.

According to one embodiment, the styrene monomer/nitrile monomer molar ratio ranges from 0.7 to 1.3.

According to one embodiment, the vinylidene fluoride copolymer of the invention is a melt-convertible heterogeneous thermoplastic copolymer, and comprises two or more co-continuous phases, said co-continuous phases comprising:
a) from 25% to 50% by weight of a first co-continuous phase comprising 90% to 100% by weight of vinylidene fluoride monomer units and 0% to 10% by weight of units of at least one other fluoromonomer, and
b) from more than 50% by weight to 75% by weight of a second co-continuous phase comprising from 65% to 95% by weight of vinylidene fluoride monomer units and one or more comonomers chosen from the group consisting of hexafluoropropylene and perfluoro(vinyl ether), to bring about the phase separation of the second co-continuous phase from the first co-continuous phase.

Said heterogeneous copolymer contains two or more phases that produce a co-continuous structure in the solid state. The co-continuous phases are distinct from each other and can be observed with a scanning electron microscope (SEM). The heterogeneous copolymers according to the invention differ from homogeneous copolymers, which comprise a single phase.

The first co-continuous phase is rich in vinylidene fluoride monomer units, containing at least 90% by weight, and preferably at least 98% by weight, of vinylidene fluoride monomer units. In one embodiment, the first co-continuous phase is a polyvinylidene fluoride (PVDF) homopolymer.

If the first co-continuous phase is a copolymer, it may be formed of one or more other fluorinated monomers chosen from the group: hexafluoropropene, tetrafluoroethylene, trifluoroethylene, chlorotrifluoroethylene, vinyl fluoride, pentafluoropropene, perfluoro(methyl vinyl ether), and perfluoro(propyl vinyl ether).

If the comonomer is the same as the primary comonomer in the second co-continuous phase, then no more than 10% of this comonomer can be present in the first co-continuous phase, since the polymers in the phases must be sufficiently different to form thermodynamically separate phases. In one embodiment, the difference in the level of a common comonomer between the copolymers of the first and second phases must be at least 10% in absolute value.

The second phase containing a copolymer will thermodynamically separate from the first phase to form a heterogeneous composition having a co-continuous structure. The copolymer contains an effective amount of a comonomer chosen from hexafluropropylene (HFP) and perfluoroalkyl ethers (PAVE), chlorotrifluoroethylene (CTFE), trifluoroethylene, with a majority (more than 50% by weight) of vinylidene fluoride monomer units. Preferably, the second co-continuous phase contains at least 1% by weight of HFP or PAVE. The copolymer may also contain other co-monomers which are copolymerizable with VDF.

The effective amount of comonomer is the amount which allows the copolymer to form a separate phase distinct from the first phase. When the comonomer is HFP, an effective amount in the second-phase polymer is from 5% to 35% by weight, preferably from 15% to 33% by weight, and more preferably from 26% to 31% by weight. The perfluoroalkyl ethers useful in the invention are those having the structure: CF₂═CF—O—Rf, where Rf is one or more perfluoroalkyl groups chosen from —CF₃, —CF₂CF₃ and —CF₂CF₂CF₃. A preferred perfluoroalkyl vinyl ether is perfluoro(methyl vinyl ether).

The co-continuous copolymer contains from 2.5% to 31% by weight of HFP and/or PAVE, more preferably from more than 2.5% to 26% by weight, and more preferably from 13% to 23% by weight, based on the total amount of all the monomers.

According to one embodiment, said membrane consists of a base film made of vinylidene fluoride copolymer, said copolymer comprising a VDF-rich, highly crystalline phase which may contain up to 10% of HFP and an amorphous phase based on a VDF-HFP copolymer containing more than 5% of HFP and up to 35% of HFP, based on the total weight of the copolymer.

The heterogeneous copolymers forming the base film of the membrane according to the invention can be synthesized according to the process described in document WO 2016/130413, which comprises the steps consisting in:
a) charging to a reactor an initial feedstock comprising water, a surfactant, vinylidene fluoride, and an initiator;
b) initiating the polymerization;
c) introducing into the reactor a feedstock comprising vinylidene fluoride and an initiator until 25% to less than 50% by weight of the total weight of vinylidene fluoride to be used in the reaction has been introduced into the reactor, to form a first-phase polymer;
d) adding to the reactor a comonomer chosen from the group consisting of hexafluoropropylene and perfluoroalkyl vinyl ether in an effective amount to cause the vinylidene fluoride copolymer formed as the second-phase copolymer to phase separate from the first-phase polymer;
e) continuing the supply of vinylidene fluoride and initiator until all of the vinylidene fluoride has been added to the reactor, to form a heterogeneous, co-continuous polyvinylidene copolymer composition; and
f) removing the co-continuous polyvinylidene fluoride copolymer composition from the reactor.

This copolymer is converted into film form by any technique known to those skilled in the art: extrusion-blow molding, flat-film extrusion but also, for example, film production by solvent casting.

According to one embodiment, the film has a thickness ranging from 5 to 150 μm, and preferably between 15 and 120 μm.

According to a second aspect, the invention relates to a process for producing the proton exchange polymer electrolyte membrane, said process comprising the irradiation-induced grafting of a VDF copolymer film with a mixture of styrene and nitrile monomers, followed by a post-treatment of the film thus irradiated and grafted, by sulfonation.

According to one embodiment, in order to prepare the electrolyte membrane according to the invention, the base film described above is first exposed to ionizing radiation in order to introduce active sites. The film is irradiated by an electron beam, gamma ray or X-ray source at a dose of between 25 and 150 kgray and preferably between 50 and 125 kgray. The irradiation takes place under vacuum, under air or under nitrogen. The irradiated base polymer is then exposed to a monomer mixture comprising a styrene monomer and a nitrile monomer.

According to one embodiment, said styrene monomer is of alpha-alkylstyrene type, with the alkyl group chosen from: methyl, ethyl, propyl, butyl, pentyl, and hexyl.

According to one embodiment, said styrene monomer is chosen from the group: α-methylstyrene, α-fluorostyrene, α-bromostyrene, α-methoxystyrene and α,β,β-trifluorostyrene.

According to one embodiment, said styrene monomer is α-methylstyrene (AMS).

According to one embodiment, said nitrile monomer is chosen from the group: acrylonitrile, 2-methyl-2-butenenitrile, 2-methylene glutaronitrile and methylacrylonitrile.

According to one embodiment, the film is passed into a bath of isopropanol at 60° C. containing between 30% and 50% of alpha-methylstyrene and between 30% and 50% of methylene glutaronitrile, before being rinsed with isopropanol.

According to one embodiment, said nitrile monomer is 2-methylene glutaronitrile (MGN).

According to one embodiment, the base film described above is irradiated in the presence of a mixture of monomers comprising said styrene monomer and said nitrile monomer. The film is irradiated by an electron beam, gamma ray or X-ray source at a dose of between 25 and 150 kgray and preferably between 50 and 125 kgray. The irradiation is carried out under vacuum, under air or under nitrogen.

The grafted film is then subjected to a post-functionalization reaction with chlorosulfonic acid, followed by hydrolysis in water or an alkaline solution. This enables the cation exchange —SO₃H function to be introduced onto the film.

According to one embodiment, the grafted film bearing the covalently bonded —SO₃H functions is then rinsed with distilled water until the rinsing water has a neutral pH, before being hydrolysed at 80° C., and then dried in air. The thickness and weight of the film thus produced increase by 30% to 80%.

Measurements by transmission infrared (IR) spectroscopy, via a calibration curve based on the ratio between the area of a specific peak of the aromatic group and/or of a specific peak of the nitrile group relative to a PVDF reference peak, show a degree of grafting, by weight, of between 25% and 55%, preferably between 35% and 50%.

Advantageously, the ion exchange capacity (IEC) of the electrolyte membrane is greater than 0.6 mmol/g. The IEC is measured as follows: a 1 cm×1 cm sample is immersed in a 0.5M solution of KCl overnight with stirring. The hydrogen ions present in the solution, after exchange with K⁺ on the sulfonate groups, are then titrated to pH=7 with a 0.05 M KOH solution. The ion exchange capacity is then calculated according to the equation below:

$$IEC = \frac{n ( {H}^{+} )}{{W}_{dry}} = \frac{c ( KOH ) \times V ( KOH )}{{W}_{K} - [ M ( {K}^{+} ) - M ( {H}^{+} ) ] [ c ( KOH ) \times V ( KOH ) ]}$$

where n(H⁺) is the number of moles of protons. Wary is the weight of the dry membrane in its H⁺ form, c(KOH) is the concentration of KOH, V(KOH) is the volume of the KOH solution added for the titration, WK is the weight of the dried membrane in its K⁺ form, and M(K⁺) and M(H⁺) are the molar masses of K⁺ and H⁺, respectively.

Advantageously, according to one embodiment, the hydrogen permeability of the electrolyte membrane according to the invention is less than 2 mA/cm². For this measurement, the membrane is placed in a cell of a fuel cell and then a stream of hydrogen is applied at the cathode while a stream of nitrogen is applied at the anode. A potential is then applied on both sides and the current obtained by the transport of hydrogen through the membrane is measured.

Advantageously, according to one embodiment, the hydrogen permeability of the electrolyte membrane according to the invention is less than 2×10⁻² mL/min·cm². For this measurement, the membrane is placed in a cell of a permeameter coupled to a gas chromatograph. The permeameter cell is purged with helium and then a stream of hydrogen is applied to the upper face of the membrane at a pressure of 0.1 MPa. The stream of hydrogen which diffuses through the membrane into the lower part is then measured by gas chromatography.

Dynamic mechanical analysis (DMA) between −40° C. and 140° C. shows that the membrane does not melt, which allows use at higher temperatures than for known membranes, especially at temperatures above 80° C. Its elongation at break, measured at 23° C. under 50% relative humidity at a speed of 20 mm/minute, for a film thickness of 30 μm, is greater than 100%.

According to another aspect, the invention relates to the applications of the proton exchange polymer electrolyte membrane, in the following fields:
fuel cells, for example H₂/air or H₂/O₂ fuel cells or methanol/air fuel cells;
electrolyzers;
lithium batteries, it being possible for said membranes to be part of the composition of the electrolytes.

According to one embodiment, the polymer electrolyte membrane is intended to be inserted into a fuel cell device within an electrode-membrane-electrode assembly.

These membranes are advantageously in the form of thin films, having, for example, a thickness of 10 to 200 micrometers.

To prepare such an assembly, the membrane may be placed between two electrodes. The assembly formed by the membrane arranged between the two electrodes is then pressed at an appropriate temperature in order to obtain a good electrode-membrane adhesion.

The electrode-membrane-electrode assembly is then placed between two plates ensuring electrical conduction and the supply of reactants to the electrodes. These plates are commonly referred to as bipolar plates.

1. A proton exchange polymer electrolyte membrane, said membrane consisting of an irradiated vinylidene fluoride copolymer base film onto which are grafted a styrene monomer and nitrile monomer, said film bearing proton exchange sulfonate groups covalently bonded to the vinylidene fluoride copolymer, said copolymer having a heterogeneous structure of co-continuous type.

2. The proton exchange polymer electrolyte membrane of claim 1, wherein the vinylidene fluoride copolymer is a melt-convertible heterogeneous thermoplastic copolymer, and comprises two or more co-continuous phases, said co-continuous phases comprising:
a) from 25% to 50% by weight of a first co-continuous phase comprising 90% to 100% by weight of vinylidene fluoride monomer units and 0% to 10% by weight of units of at least one other fluoromonomer, and
b) from more than 50% by weight to 75% by weight of a second co-continuous phase comprising from 65% to 95% by weight of vinylidene fluoride monomer units and one or more comonomers chosen from the group consisting of hexafluoropropylene and perfluoro(vinyl ether), to bring about the phase separation of the second co-continuous phase from the first co-continuous phase.

3. The membrane of claim 2, wherein said first co-continuous phase contains at least 90% by weight of vinylidene fluoride monomer units, and one or more other fluorinated monomers chosen from the group consisting of: hexafluoropropene, tetrafluoroethylene, trifluoroethylene, chlorotrifluoroethylene, vinyl fluoride, pentafluoropropene, perfluoro(methyl vinyl ether), and perfluoro(propyl vinyl ether).

4. The membrane of claim 2, wherein said copolymer comprises a vinylidene fluoride (“VDF”)-rich, highly crystalline phase which may contain up to 10% of hexafluoropropene (“HFP”) and an amorphous phase based on a VDF-HFP copolymer containing more than 5% of HFP and up to 35% of HFP, based on the total weight of the copolymer.

5. The membrane of claim 1, wherein said film is grafted with α-methylstyrene and 2-methylene glutaronitrile and is functionalized with chlorosulfonic acid.

6. The material of claim 1, wherein the styrene monomer/nitrile monomer molar ratio ranges from 0.7 to 1.3.

7. The membrane of claim 1, having a hydrogen permeability of less than 2×10⁻² mL/min·cm².

8. The membrane of claim 1, having an ion exchange capacity (IEC) of greater than 0.6 mmol/g as measured by titration with a 0.05M KOH solution.

9. A process for producing the proton exchange polymer electrolyte membrane of claim 1, said process comprising irradiating a vinylidene fluoride copolymer film to produce an irradiated vinylidene fluoride copolymer film, grafting onto the irradiated vinylidene fluoride copolymer film a mixture of styrene and nitrile monomers, followed by a post-treatment of the film thus irradiated and grafted, by sulfonation.

10. The process as claimed in claim 9, comprising the steps of:
a) exposing said film to ionizing radiation chosen from electron beams, gamma rays, or X-rays;
b) exposing the irradiated film to a mixture of monomers comprising a styrene monomer chosen from the group consisting of: α-methylstyrene, α-fluorostyrene, α-bromostyrene, α-methoxystyrene, α,β,β-trifluorostyrene, and a nitrile monomer chosen from the group: acrylonitrile, 2-methyl-2-butenenitrile, 2-methylene glutaronitrile and methylacrylonitrile;
c) subjecting the grafted film to a post-functionalization reaction with chlorosulfonic acid, followed by hydrolysis in water or an alkaline solution.

11. A fuel cell comprising e the proton exchange polymer electrolyte membrane of claim 1.
